(19) United States
(12) Patent Application Publication
(10) Pub. No.: US 2003/0008950 A1
(43) Pub. Date: Jan. 9, 2003

(54) Radiation-curable compositions for optical media

(75) Inventors: Chander P. Chawla, Batavia, IL (US); Michael G. Sullivan, Belvidere, IL (US); Vadim V. Krongauz, Bartlett, IL (US); Christopher F. Tronche, Schaumburg, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: DSM N.V., Heerlen (NL)

(21) Appl. No.: 10/008,489

(22) Filed: Nov. 13, 2001

Related U.S. Application Data
(60) Provisional application No. 60/248,175, filed on Nov. 13, 2000.

(51) Int. Cl. C08K 5/34; C08K 5/35; C08K 5/46; C08K 5/48

(52) U.S. Cl. 524/83; 524/87; 524/92; 524/95

(57) ABSTRACT

Optical disc adhesives and lacquers comprising components that undergo free-radical polymerization when exposed to radiation and a cure-enhancing amount of R-SH, wherein R is a heterocycle; cationic, free-radical, and hybrid adhesives for digital versatile discs (DVD) comprising components that undergo cationic and/or free-radical polymerization when exposed to radiation and a corrosion-inhibiting amount of R-SH, R1-R2 and/or an acyclic thiol, wherein R is a heterocycle, R¹ is a substituted or unsubstituted phenyl as a substituent of R² or forming with R² a bicyclic structure, and R² is a heterocycle comprising at least one double bond and at least two N atoms; and optical media, e.g., CD-DA, CD-ROM, CD-R, DVD, and the like, that include one, or a combination, of the foregoing inventive adhesive or lacquer compositions.

This application claims the benefit of U.S. provisional patent application No. 60/248,175, filed Nov. 13, 2000, which is incorporated by reference.

### TECHNICAL FIELD OF THE INVENTION

The present invention generally pertains to radiation-curable compositions for optical media.

### BACKGROUND OF THE INVENTION

In response to the demand for more reliable and higher capacity data storage and retrieval systems, considerable research and development is undertaken on optical media. One form of optical media is an optical disc. The optical disc is encoded with information, and serves as the storage component of data storage and retrieval systems. Optical discs are presently available in a variety of formats including, but not limited to, CD-DA (compact disc-digital audio which includes the common music CD), CD-ROM (compact disc-read only memory), CD-WORM (write-once-read-many), CD-R (compact disc-recordable) and DVD (digital versatile disc), the latter category including, but not limited to, DVD-R, DVD-RW, DVD-RAM, DVD-5, DVD-9 and DVD-18.

Generally, all optical discs include a substrate (in a DVD, at least two substrates held together by an adhesive), a means for encoding data, one or more reflective and/or semi-reflective layers and, typically, a coating commonly referred to as a lacquer. The substrate is typically a disc comprised of polycarbonate, PMMA or PECHE, with an opening for a spindle provided in the center of the disc. The encoding of data on an optical disc, in what will be referred to herein as a data layer, can be accomplished in several ways, and in one or more data layers, depending on the desired format. For example, a CD-ROM and DVD encode data directly on the substrate by providing a series of pits and lands on the substrate surface. In contrast, a CD-R and DVD-R utilize a separate data encoding medium, e.g., a dye or other type of data encoding material that is separate and apart from the substrate, as its data layer.

At least one reflective and/or semi-reflective layer is required on all optical discs because the data layer of such discs is accessed using laser light. More specifically, and as is well known, these layers, as their name implies, function to reflect laser light onto a detector so the data can be retrieved and subsequently converted into a usable format. To provide the disc with this reflective capability, at least one extremely thin (50-500 nm) reflective metallic (e.g., silicon carbide, silicon nitride, gold, silver, copper, aluminum or other known reflective metallic alloy) material is deposited (e.g., sputtering, vacuum evaporation) over the data layer of the optical disc. During the data retrieval (reading) process, the laser focuses on and tracks the data located on the optical disc. Because the data layer affects the properties of the laser light, an appropriate detector is able to sense these property differences in the reflected laser light and convert them into a binary (1's and 0's) signal. The binary signal is then further processed to provide the desired output to the user.

The capacity of a single-sided DVD disc may be almost doubled by applying a semi-reflective data layer (comprising, e.g., gold, silver, silicon or the like) over a reflective layer (comprising, e.g., aluminum). The data associated with the semi-reflective layer can be read using a relatively low-powered laser, with the data associated with the reflective layer being read using a relatively high-powered laser.

The data layer of a DVD, like that of a CD-ROM, comprises a series of pits and lands embossed on the surface of the optical disc substrate. However, to enhance the data capacity of a DVD, two optical discs are typically adhered to one another, with the metallic reflective layers of each disc oriented in back-to-back relation. Currently, there are several types of adhesive systems available for adhering these two optical discs to one another to provide a DVD: hot melt contact adhesives, cationic (or PCA) UV bonding, free radical UV bonding, and a hybrid system comprising a combination of the latter two bonding systems. Although cationic bonding provides excellent adhesion, it unfortunately corrodes the reflective metal layer. This corrosion, in turn, causes incomplete or inaccurate data retrieval. In an effort to circumvent this problem, specialized protective coatings are typically applied over the reflective metal layers of such individual DVD discs prior to the application of such cationic adhesives thereto.

While there exits at present many lacquer compositions that are promoted for use in connection with optical discs, such compositions are almost universally radiation-curable. Radiation-curable lacquers have been utilized, in part, due to their ability to provide an acceptable coating under high speed processing conditions. These compositions are typically produced from an uncured mixture of ingredients, commonly including reactive acrylates, which are applied onto the optical disc, and then cured upon exposure to radiation, e.g., electron beam or UV radiation.

While enabling high speed optical disc production is important, lacquer compositions must satisfy a number of other stringent requirements. An acceptable lacquer composition must be compositionally stable both prior to (storage stability) and after curing (so that the cured coating layer maintains its useful properties for long periods of time). After curing, the lacquer must provide adequate levels of abrasion resistance, exhibit a low level of shrinkage, have appropriate levels of hardness and adhesion, and resist delamination. The cured lacquer and adhesives must also be compatible with the optical disc as a whole, not cause any problems with data retrieval or the reflective material. Further, they should not adversely affect the properties of the optical disc, nor be adversely affected itself, even after the optical disc is exposed to elevated temperatures and humidity levels.

The adhesives used in the preparation of DVDs, to be acceptable, should exhibit a high cure speed, a suitable viscosity, and should wet the substrates adequately to maximize adhesion of the substrates to one another. After curing, these materials should further provide: high dimensional stability even after exposure to high temperature and humidity levels, acceptable shrinkage, optical compatibility resistance and durability.

Thus, there exists a need for optical disc adhesives and radiation-curable lacquers, and optical discs comprising those adhesives and lacquers, that provide enhanced performance relative to existing compositions and discs.

### SUMMARY OF THE INVENTION

In one aspect, the present invention provides cationic, free-radical, and hybrid adhesives for optical media, such as digital versatile discs (DVD), comprising components that undergo cationic and/or free-radical polymerization when exposed to radiation and a corrosion-inhibiting amount of R-SH, R¹-R², and/or acyclic thiol, wherein R is a heterocycle, R¹ is a substituted or unsubstituted phenyl as a substituent of R² or forming with R² a bicyclic structure, and R² is a heterocycle comprising at least one double bond and at least two N atoms.

In a further aspect, the present invention provides adhesives and lacquers for optical media comprising components that undergo free-radical polymerization when exposed to radiation and a cure-enhancing amount of a heterocyclic compound comprising a N atom and a double bond.

Related aspects of the present invention include various optical media that include one, or a combination, of the inventive compositions, e.g., CD-DA, CD-ROM, CD-R, DVD, and the like.

### BRIEF DESCRIPTION OF THE DRAWINGS

FIG. 1 is a cross-sectional view of a portion of a CD-R optical disc that uses a dye as the data layer.

FIG. 2 is a cross-sectional view of a portion of a double-sided, single layer, DVD optical disc.

FIG. 3 contains Fourier Transform IR (“FTIR”) curves for three hexanediol diacrylate (“HDDA”) free-radical, radiation-curable compositions.

FIG. 4 plots the % RAU of a HDDA composition containing a particular photoinitiator (Irgacure 184) at three discrete exposures (2, 5 and 20 seconds) relative to mercaptobenzoxazole (“MBO”) concentration.

FIG. 5 plots the % RAU of a HDDA composition containing a particular photoinitiator (Irgacure 651) at three discrete exposures (2, 5 and 20 seconds) relative to MBO concentration.

FIG. 6 plots the % RAU of an isobornylacrylate (“IBOA”) composition containing a particular photoinitiator (Irgacure 184) at three discrete exposures (2, 5 and 10 seconds) relative to MBO concentration.

FIG. 7 plots the % RAU of an IBOA composition containing a particular photoinitiator (Irgacure 184) at three discrete exposures (2, 10 and 20 seconds) relative to mercaptobenzothiazole (“MBT”) concentration.

FIG. 8 plots the % RAU of an IBOA composition containing a particular photoinitiator (Irgacure 651) at three discrete exposures (2, 10 and 20 seconds) relative to MBT concentration.

FIG. 9 contains FTIR curves for three IBOA radiation-curable compositions.

### DETAILED DESCRIPTION OF THE PREFERRED EMBODIMENTS

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

In one aspect, the present invention contemplates the inclusion of the R-SH, R¹-R² and/or acyclic thiol components, in corrosion-inhibiting amounts, in adhesive compositions for optical media, most desirably for DVDs. Adhesives that will benefit from the invention include free-radical, cationic and hybrid adhesives. All such adhesives are preferably non-aqueous in nature.

The corrosion-inhibiting components may be described as acyclic thiols, R-SH and/or R¹-R², wherein R is a heterocycle, R¹ is a substituted or unsubstituted phenyl as a substituent of R² or forming with R² a bicyclic structure, and R² is a heterocycle comprising at least one double bond and at least two N atoms. In these compounds, R, R¹ and R² may be substituted or unsubstituted.

Turning initially to the R-SH compounds, R is desirably substituted with an aromatic ring, e.g., a phenyl group, which itself may be substituted or unsubstituted. R may also be a single ring, or a bicyclic compound. In the latter case, the bicyclic compound preferably comprises the heterocycle and a substituted or unsubstituted phenyl.

It should be appreciated that when one -SH substitutent is included in the corrosion-inhibiting compound, more than one such substituent may be included therein. Further, when a bicyclic or substitued single ring heterocycle is desired, the -SH substituent is more desirably a substituent of the heterocyle. Most desirably, the heterocyclic ring includes a double bond adjacent the -SH substituent.

In addition to at least one carbon atom, R may further include N, O and/or S in its ring structure, and preferably from two to four N, O or S atoms. Desirably, R includes N as at least one of those atoms.

It is preferred that R-SH is a bicyclic compound, and more preferred that it includes at least two of N, S or O in the heterocyclic ring, one of which is N, with the -SH substituent located on the heterocycle portion thereof, and adjacent a double bond.

Illustrative R-SH corrosion-inhibiting compounds contemplated by the present invention include phenyl-or benzo-azole thiols, and other thiols, with specific examples including:

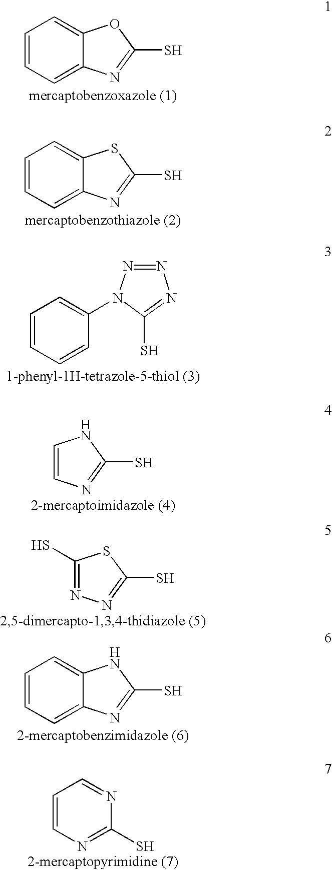

and mixtures thereof

Turning now to the R¹-R² compound, it should be appreciated that this compound need not contain a thiol substituent, although the inclusion of this substituent is optional. In this compound, R¹ is a substituted or unsubstituted phenyl as a substituent of R² or forming with R² a bicyclic structure, and R² is a heterocycle comprising at least one double bond and at least two N atoms. Desirably, R² is a single ring including at least three N atoms, and preferably R¹ is a substituent of R².

Illustrative R¹-R² compounds contemplated by the present invention include 5-phenyl-l-H-tetrazole (8)

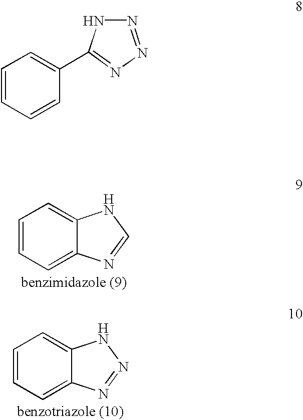

and mixtures thereof.

Of the preferred corrosion-inhibiting compounds, Compounds 1-5 and 8 are most preferred based on their performance, with Compounds 1-3, 5 and 8 having the further advantage of being relatively low in cost. Compounds 6, 7, 9 and 10 offer slightly lower, yet adequate, performance on a per weight basis relative to Compounds 1-5 and 8, with Compounds 6, 9 and 10 being particularly preferred due to their relatively low cost.

It has been found that the foregoing R-SH and R¹-R² compounds, when introduced into adhesives commonly used in the manufacture of DVDs, inhibit the reflective layer corrosion-inducing characteristic of these adhesives. However, it was further found that the use of relatively low amounts of these components is desirable, e.g., no more than about 0.5 wt. % based upon the total weight of the uncured adhesive, because relatively low cure rates and overall cure, and other performance problems, were determined to accompany excessive levels of these compounds. Lower levels, which inhibit corrosion while also providing for a lessening of the foregoing adverse effects and lowering cost, are therefore desirably used. More specifically, the total amount of these compounds is desirably limited to no more than about 0.3 wt. %, preferably to no more than about 0.1 wt. %, more preferably to no more than about 0.05 wt. %, and most preferably to no more than about 0.01 wt. %, based upon the total weight of the uncured adhesive composition.

The present invention further contemplates the inclusion of acyclic thiol compounds in radiation-curable compositions for optical media. The acyclic thiols comprise at least one thiol functional group and at least one, and advantageously a plurality of, additional functional groups that interact with the reflective or semi-reflective surface.

While the acyclic thiol may be of any length, their length is desirably limited to no more than about 16 atoms, and preferably from 4 to 14 atoms, for the reasons set forth below. While the content of the acyclic chain in these thiols may include carbon atoms alone, it desirably further includes at least one, preferably at least 2, and more preferably up to 4, heteroatoms, e.g., N, S or 0. Most preferably, the acyclic chain will include a plurality of nitrogen atoms.

While not desiring to be bound to a particular theory, it is believed that the foregoing relatively short-chain acyclic thiols permit the thiols to migrate through the composition to the reflective surface, which surface is typically metallic, where they can perform their corrosion-inhibiting function. It is believed that relatively longer-chain thiols will experience greater difficulty in completing this migration due to physical entanglements, and thus will be less effective. In this regard, and while the acyclic thiols may comprise straight or branched chains, they are advantageously straight chained to enhance their migration.

Moreover, the inclusion of at least one additional functional group, in addition to the thiol group, as part of the acyclic thiol is believed to enhance the interaction with the reflective metallic surface, effectively reducing the formation of corrosion thereof. Illustrative of these additional metallic-interacting functionalities are polar groups, e.g., carbonyl, hydroxyl and amino groups.

The amount of acyclic thiols contemplated for use in the inventive curable compositions will vary depending on the particular thiol selected, but may generally be used at levels ranging from about 0.001 wt. % to about 1 wt. %. The level of this component is advantageously limited to only that required to provide the desired results, as it is believed such thiols will have an adverse effect on curing when included at relatively high levels. Preferably, the thiols are included at levels raging from about 0.005 wt. % to about 0.5 wt. %, and more preferably from about 0.1 wt. % to about 0.3 wt. %.

For purposes of the present invention, determining the extent of corrosion in the reflective and/or semi-reflective layers of optical media, and thus whether a sufficient amount of the corrosion-inhibiting compound has been provided in the adhesive or lacquer compositions, may be undertaken by various methods, including those set forth below.

For example, and in the case of CD-Rs, the extent of corrosion may be determined after exposure of these discs to different environments. The first environment is 85° C./85% relative humidity. The second environment is an aqueous 5 wt. NaCl solution. The exposure time of the CD-R disc in each environment is at least 48 hours. After exposure to one or both environments, the disc is placed between a light source (e.g., fluorescent light) and an observer. Corrosion is present when at least a portion of the CD-R exhibits increased light transmission relative to the light transmission of the same CD-R prior to its exposure in the aforementioned environments. More specifically, corrosion, if present, will appear as: pinholes in the semi-reflective layer (when the disc is placed between a light source and the observer) (indicating slight corrosion), generally circular patterns similar in size and appearance to very small dried water droplets (indicating moderate corrosion), or large areas of semi-reflective layer degradation which permit objects to be discerned therethrough (indicating severe corrosion). The relative severity of corrosion may also be determined by measuring any increase in light transmissivity, i.e., comparing the transmissivity of visible light through a CD-R both before and after exposure to the foregoing environments. An increase in transmissivity indicates the presence of corrosion. If delamination of the lacquer occurs over a portion of the CD-R during exposure, however, the transmissivity should be based upon that portion of the CD-R which has not experienced delamination.

By way of further example, and in the case of DVDs, visual obervation may also be used to identify any corrosion after the DVD is exposed to a 80° C./85% relative humidity environment. In DVDs, corrosion appears as pinholes or very small dried water droplets on at least a portion of the DVD surface. The greater the concentration of these imperfections, the greater the severity of the corrosion. The DVD may be examined for corrosion at any interval during exposure, but a corrosion evaluation is typically undertaken after at least 48 hours of exposure to the 80° C./85% relative humidity environment.

A measure of the extent of DVD corrosion may also be obtained by determining the reflectivity of a portion of the disc (i.e., the most reflective portion) as a function of time. Any suitable device may be used, such as a MacBeth Color Spectraphotometer 7000. When corrosion is present, the reflectivity of the DVD (measured using 635 nm and 650 nm radiation) will be lower relative to the DVD before exposure to the aforementioned environment. These reflectivity determinations are most useful in confirming the presence or absence of corrosion when a visual inspection fails to reveal any corrosion on a DVD.

As mentioned, the area of the media affected by corrosion, like the severity of corrosion, will also provide information pertinent to the effectiveness of a particular corrosion inhibiting compound, and the proper amount to include in a radiation-curable composition. In this regard, the extent of corrosion may be measured by determining the percent of the total area affected by corrosion. Generally, after exposure to the foregoing harsh environments for at least 48 hours, any corrosion present on the media desirably should be limited to no more than about 15% of the surface area (as observed on a single side) of the media. More desirably, the extent of corrosion is limited to no more than about 10%, preferably no more than about 5%, and most preferably no more than about 1%, based on the total surface area of one side of the optical media.

The extent of corrosion inhibition provided by the inventive compositions, and also a corrosion-inhibiting amount of the thiols described herein, may be determined by a comparative study. Inhibition is provided when the extent of (area affected) or severity of corrosion (as determined using the foregoing methods) in an optical disc onto which a composition containing a corrosion inhibitor has been applied is lower than the corrosion level of the same type of optical disc to which the same composition, but without the corrosion inhibitor, has been applied.

The time of exposure of the optical media (e.g., CD-R, DVD, DVD-R) to the relatively severe environments described herein, while typically at least about 48 hours, may be extended to at least 96 hours, 192 hours, and up to 230 hours and beyond. Advantageously, optical media which include the preferred lacquers and adhesives exhibit no corrosion after exposure to their respective environments over at least 48 hours, and preferably over the longer periods set forth above.

Separate and apart from the beneficial properties described herein, optical media prepared using an adhesive may be subjected to a number of other tests in order to evaluate adhesive performance. For example, two discs adhered to one another during the manufacture of a DVD with an acceptable adhesive should: remain adhered to one another after the DVD is dropped, on its edge, onto a concrete floor from a height of about 75 cm; not delaminate even after exposure to an environment consisting of 80° C./85% relative humidity for at least 1000 hours, or preferably, after 2000 hours; exhibit a cured film elongation at break of at least 20%, and more preferably at least 50%; exhibit shrinkage upon cure of no greater than about 10%; and exhibit a shear strength of about 10 lbs to about 100 lbs (opposing shearing force causing failure as measured by INSTRON™ 4201). From a processing perspective, suitable adhesives should be dry to the touch after curing. Other desirable properties of optical disc adhesives are discussed in a number of U.S. patents, including U.S. Pat. Nos. 4,861,637, 4,906,675, and 5,213,947. It was found that, if a DVD adhesive containing one, two or all of the corrosion-inhibiting compounds described herein (i.e., R-SH, R¹-R², and/or acyclic thiol) does not meet one or more of these criteria, a downward adjustment in the concentration of the corrosion-inhibiting compound should be considered before a re-formulation of the adhesive as a whole is undertaken.

One type of adhesive commonly used in the manufacture of optical media, such as DVDs, is a cationic adhesive. This type of adhesive offers certain benefits when so used. For example, these adhesives, relative to free-radical adhesives, generally provide slightly slower cure rate, no oxygen sensitivity, are initiated by radiation and heat (as opposed to radiation only), less shrinkage, better adhesion, and better humidity and acid resistance. For this reason, cationic adhesives are preferred in the context of the present invention.

In cationic adhesives, cycloaliphatic epoxy resins may comprise at least 30 wt. %, desirably at least 40 wt. %, and preferably at least 50 wt. % of the adhesive formulation. Other components that may be included in such adhesives include polyols, e.g., caprolactone polyols, phenolic polymers, e.g., Novolac, DGEBA epoxies, castor oil, aliphatic epoxides, limonene oxide, epoxidized oils, and mixtures thereof.

Advantageously, the cationic adhesive is substantially free of non-acrylated polyols, e.g., C₁-C₈ alkanols. More specifically, it was found that excessive levels of these polyols retarded cure speed, and increased corrosion. Preferably, then, if present, the non-acrylated polyol level may be maintained at no greater than about 1.0 wt. %, more preferably no more than about 0.5 wt. %, and most preferably no more than about 0.1 wt. %, based on the uncured adhesive composition.

Photoinitiators used in cationic adhesives are well known, typically comprising onium salts, ferrocenium salts, or diazonium salts. Preferably, aryl sulfonium salts are used, but iodonium salts are also used, both with a variety of counter ions. Upon irradiation with ultraviolet light, these photoinitiators generate strong acids that cause a rapid ring-opening, whereby cycloaliphatic epoxies crosslink with each other and also with hydroxyl compounds, if the latter are present. Examples of cationic photoinitiators include diaryl iodonium hexafluoroantimonate, triaryl sulfonium hexafluoroantimonate, triaryl sulfonium hexafluorophosphate, and mixtures thereof.

It is desirable to coordinate the amount of photoinitiator included in the composition with the amount, if any, of non-acrylated polyol therein. For example, as the amount of such polyols is reduced, the cure speed is increased. As cure speed generally increases with increasing photoinitiator content, it is advantageous to reduce the amount of photoinitiator with a reduction in non-acrylated polyol. This not only decreases costs, but lowering the photoinitiator provides a corresponding decrease in corrosion of the metallic reflective surface of the optical disc.

Hybrid DVD adhesive systems are characterized by their ability to cure in combination by cationic/free radical polymerization. These adhesives are also well-known and may include, for example, (meth)acrylated epoxides, such as (meth)acrylate modified cycloaliphatic epoxides, as well as partially acrylated bisphenol-A epoxy resins, and the like.

In another aspect, the present invention provides adhesives and lacquers for optical media that comprise a component that undergoes free-radical polymerization when exposed to radiation, a photoinitiator, and a cure-enhancing amount of a N-containing heterocyclic compound which includes at least one double bond.

It was discovered that N-containing heterocyclic compounds, when added to these compositions in limited amounts, provide the compositions with, among other desirable properties, enhanced curing characteristics relative to counterpart compositions in which such compounds are absent. For example, the inventive compositions exhibit a higher cure rate (% RAU/sec), as well as a higher degree of cure (% RAU), at a preselected level of radiation exposure (energy level and exposure time).

With regard to adhesive compositions, it was surprisingly discovered that the foregoing beneficial effects were present even when such compounds were included in DVD adhesives cured in oxygen-containing (e.g., ambient air) environments, as oxygen-rich environments would be expected to diminish the foregoing benefits provided by the N-containing heterocyclic compounds. However, it was found that, because the adhesive surface area of a DVD is limited to the edge of the DVD, the resulting exposure to oxygen (even an oxygen-rich environment), would not unduly inhibit the cure-enhancing effect of the N-containing heterocyclic compound, and as such these compounds could be beneficially included in DVD adhesives containing free-radical-curing components.

It was further discovered, however, that adding N-containing heterocyclic compounds to free-radical-curing compositions could not be done indiscriminately. The amount of such compounds in the foregoing compositions should be limited, based in part upon the further discovery that excessive amounts of such compounds may have a deleterious effect on curing and other properties. For example, excessive addition of the N-containing heterocyclic compounds was found to inhibit the cure rate, and degree of cure (%RAU), of radiation-curable optical disc compositions.

While not desiring to be bound to any particular theory, it is believed that the N-containing heterocyclic compounds may bind some of the free oxygen dissolved in the liquid curable compositions, thus decreasing polymerization inhibition, and increasing the cure rate. That this desirable effect begin to disappear at higher concentrations is thought to be due to the compounds' inhibitory (and overriding) effect at those higher concentrations.

While the discovery described herein is believed to be broadly applicable to free-radical lacquer compositions for optical media, those skilled in the art, using the teaching provided herein, will be readily able to determine the optimal amount of N-containing heterocyclic compounds for a particular radiation-curable lacquer. While this amount will vary, it will generally not exceed about 5 wt. % of the composition. It was further discovered that the desirable cure enhancement does not vary linearly with increasing amounts of such compounds, thus, the amount of these compounds is advantageously limited to no more than about 1 wt. % of the composition. Preferably, the concentration does not exceed about 0.5 wt. %, more preferably about 0.25 wt. %, and most preferably does not exceed about 0.1 wt. %, based upon the total weight of the composition.

N-containing heterocyclic cure-enhancing compounds suitable for use in the inventive composition may be substituted or unsubstituted, and may comprise single, double or triple ring structures. Desirably, the N-containing heterocyclic structure therein includes a C atom, and more desirably contains at least two N atoms and at least one double bond. Preferably, the N-containing heterocyclic structure includes 5 or 6 members, as illustrated by Compounds 1-10 disclosed above, and Compounds 11 and 12 disclosed below:

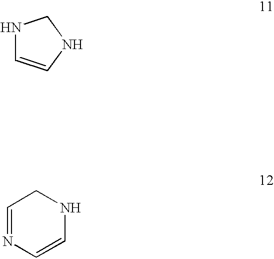

Compounds 1and 12 could, if desired, be part of a bi- or tri-cyclic compound.

Turning now to the radiation-curable compositions of the present invention, the compositions must include components that have one or more functionalities (or functional groups) which, as their name implies, cure upon exposure to radiation. One general class of radiation-curable functionality is ethylenic unsaturation. Components that include this functionality, in general, may be cured via free radical polymerization, but can be cured by cationic polymerization. Illustrative of functional groups that are ethyl enically unsaturated include (meth)acrylate (i.e., methacrylate or acrylate), styrene, vinylether, vinyl ester, N-substituted acrylamide, N-vinyl amide, maleate ester, and fumarate ester.

Other functionalities contemplated by the present invention that permit polymerization upon exposure to radiation include thiol-ene and amine-ene systems. In the thiol-ene and amine-ene systems, for example, polymerization can occur between a group containing allylic unsaturation and a group containing a tertiary amine or thiol. Of the foregoing, ethylenic unsaturation functionalities are preferred.

The majority of the components included in the inventive coatings and adhesives may be conveniently categorized as oligomers and reactive diluents. The oligomers are typically of relatively high viscosity and molecular weight, the latter advantageously in the range of above about 700, preferably above about 5,000 and most preferably above about 10,000. In contrast, reactive diluents are commonly relatively low molecular weight components which, as their name implies, function to dilute and thereby lower the viscosity of the compositions to levels acceptable to optical disc manufacturers. For example, and in the case of the lacquer composition, if spin coating is utilized, sufficient diluent is added to adjust the viscosity of the composition to less than about 700 cps at 25° C., and advantageously to between about 25 cps to about 100 cps at 25° C. The inventive coatings are preferably non-aqueous in nature.

Turning initially to the lacquer compositions, at least 40 wt. % of the oligomers and reactive diluents are advantageously multifunctional, i.e., they include more than one radiation-curable functionality. Including these multifunctional components, and particularly those components having at least three radiation-curable functionalities, enhances the hardness of the cured lacquer, and thus the protection they can offer against abrasion and degradation due to harsh environmental conditions. However, the amount of this type of component should be limited because components with at least three functionalities can have an adverse effect on certain desirable properties, e.g., delamination, shrinkage, when included in excessive amounts. In comparison, components with two radiation-curable functionalities contribute less to hardness as compared to the components having at least three functionalities. There is nevertheless some contribution in that regard, as well as a relative lessening of shrinkage coupled with an increased level of adhesion from the components with two functionalities. Monofunctional components also provide the coating with enhanced resistance to shrinkage and delamination, but do not significantly contribute to hardness.

In addition to providing acceptable levels of delamination, shrinkage and/or hardness, the lacquers of the present invention desirably exhibit acceptable levels of jitter after curing. Each of these advantageous properties are described in further detail in the following paragraphs.

Jitter is a measure of the performance of an optical disc and, generally, relates to data reading errors. It is typically utilized to evaluate the performance of a CD-R, but may be used for other types of discs.

While a disc's substrate and reflective layer are the primary contributors to jitter, a lacquer can also affect this property. More specifically, if the lacquer does not offer sufficient protection against the environment, the disc may degrade to the point where it exhibits an undesirable level of jitter.

Preferably, the jitter of an optical disc is less than about 35 nanoseconds (ns), more preferably less than about 30 ns, and most preferably no greater than about 25 ns, after exposure to a harsh environment consisting of a temperature of at least 80° C. and a relative humidity of at least 85% for a period of at least 96 hours. The test for determining optical disc jitter is provided in what is commonly referred to by those skilled in the art as the Orange Book, published by Philips NV. In particular, jitter, as set forth herein, was measured using a CD CATS (Audio Development).

One measure of the degree to which the lacquer is able to protect a disc is disc hardness. The lacquers desirably exhibit a pencil hardness value ranging from 2B to 2H after exposure to the previously described harsh environment. The pencil hardness is measured according to ASTM D3363-92A.

Shrinkage can also be a problem in lacquers. The inventive lacquers are desirably formulated to exhibit shrinkage, after curing, of no greater than about 12%, advantageously less than about 9%, preferably less than about 8% and most preferably less than about 5%. Shrinkage is determined by comparing the density of the liquid lacquer composition with the density of the cured composition as follows:

$$shrinkage ( \% ) = 100 \times \frac{\begin{matrix}density of cured composition - \\ density of liquid\end{matrix}}{density of cured composition}$$

Delamination is also of concern to disc manufacturers, who require their products to withstand the rigors of shipping and use by customers living in warm, tropical climates. With this in mind, the lacquers are formulated to advantageously provide a cured coating that, after application onto an aluminum reflective layer, exhibits delamination over less than about 10% of the area onto which the coating is applied after exposure to an environment of at least 85° C./85% relative humidity for at least 96 hours. Preferably, delamination occurs over no more than about 5%, and most preferably over no more than about 2% over the area onto which the coating is applied after exposure to the aforesaid environment for 96 hours. When the lacquer is applied over a silver reflective layer and exposed to the same environment, the cured coating advantageously exhibits delamination over less than about 25% of the area onto which the coating is applied after exposure to an environment of at least 85° C./85% relative humidity for at least 96 hours, advantageously for at least 192 hours, and preferably for at least 230 hours. More advantageously, delamination occurs over no more than about 15%, preferably over no more than about 10% and most preferably over no more than about 5%, during that same time period.

In formulating lacquers, one may advantageously include from about 50 wt. % to about 95 wt. % multifunctional radiation-curable components, and more preferably from about 60 wt. % to about 90 wt. % of these components. In contrast, monofunctional radiation-curable components may advantageously constitute less than about 20 wt. % of the composition, and preferably less than about 10 wt. % of the composition.

In the context of reactive diluents and oligomers, these lacquers generally contain from about 10 wt. % to about 90 wt. % reactive diluents, with these diluents desirably constituting a majority of the composition. Preferably, the diluents comprise at least 60 wt. %, and more preferably at least about 70 wt. %, of the composition. The oligomers are generally included in amounts ranging from about 10 wt. % to about 50 wt. %, but are desirably limited to less than about 25 wt. % of the composition, and preferably to less than about 15 wt. % thereof.

While the majority of the reactive diluents included in the lacquer compositions are multifunctional, such compositions advantageously include at least about 50 wt. %, and preferably at least about 60 wt. %, multifunctional reactive diluents. Preferably, the compositions comprise from about 10 wt. % to about 30 wt. % of reactive diluents that contain at least three radiation-curable functional groups, from about 35 wt. % to about 70 wt. % of difunctional reactive diluents, and from about 1 wt. % to about 10 wt. % of monofunctional reactive diluents.

A wide variety of reactive diluents having at least three radiation-curable functionalities are available, and are suitable for use in the lacquers and adhesives of the present invention. Illustrative of such diluents are Cₙ hydrocarbon triacrylates wherein n is an integer from 3 to 18, and the polyether analogues thereof, and the like, such as trimethylolpropanetriacrylate, pentaerythritoltriacrylate, propoxylated glycerol tri(meth)acrylate, trimethylolpropane tri(meth)acrylate, ethoxylated trimethylolpropane tri(meth)acrylate, propoxylated trimethylolpropane tri(meth)acrylate, pentaerythritol tri(meth)acrylate, pentaerythritol tetra(meth)acrylate, ditrimethylolpropane tri(meth)acrylate, dipentaerythritol penta(meth)acrylate, dipentaerythritol hydroxy penta(meth)acrylate, propoxylated glyceryl tri(meth)acrylate and mixtures thereof.

A number of suitable difunctional reactive diluents are commercialy available, and may be used in the inventive compositions. Exemplary of these diluents are: Cₙ hydrocarbondioldiacrylates wherein n is an integer from 2 to 18, Cₙ hydrocarbondivinylethers wherein n is an integer from 4 to 18, and the polyether analogues thereof, and the like, such as hexanedioldivinylether, triethyleneglycoldiacrylate, ethoxylated bispheno-A diacrylate, tripropylene glycol di(meth)acrylate, 1,6-hexanediol di(meth)acrylate, polyethylene glycol di(meth)acrylate, propoxylated neopentyl glycol di(meth)acrylate, dicyclopentyldimethylene diacrylate and mixtures thereof.

Many different monofunctional reactive diluents suitable for use in the present invention are available. Illustrative diluents include 2-(2-ethoxy)ethyl(meth)acrylate, polypropylene glycol (meth)acrylate, neopentyl glycol dialkoxy(meth)acrylate, isoborny1-(meth)acrylate, tetrahydrofurfuryl(meth)acrylate, 2-phenoxyethyl (meth)acrylate, laurylvinylether, 2-ethylhexylvinyl ether, N-vinyl formamide, isodecyl acrylate, isooctyl acrylate, vinyl-caprolactam, N-vinylpyrrolidone, and the like, and mixtures thereof.

If the radiation-curable functionality of the radiation-curable monomer or oligomer is based on an amine-ene or thiol-ene system, examples of reactive diluents having allylic unsaturation that can be used to provide a protective outer coating include diallylphthalate, triallyltrimellitate, triallylcyanurate, triallylisocyanurate, diallylisophthalate, and mixtures thereof. For amine-ene systems, other amine functional reactive diluents that can be used include, for example: the adduct of trimethylolpropane, isophoronediisocyanate and di(m)ethylethanolamine; the adduct of hexanediol, isophoronediisocyanate and dipropylethanolamine; and the adduct of trimethylol propane, trimethylhexamethylenediisocyanate and di(m)ethylethanolamine; and mixtures thereof.

Examples of oligomers that may be used in formulating the inventive compositions include polyethers, polyolefins, polyesters, polycarbonates, acrylics, or copolymer thereof, with polyesters and polyurethanes being preferred. Of these, polyester (meth)acrylates, polyurethane (meth)acrylates and (meth)acrylated epoxy (meth)acrylates are desirable, with (meth)acrylated epoxy (meth)acrylates being preferred due to their tendency toward relatively low viscosity, with enhanced levels of hardness. More specific examples of preferred oligomers for lacquers include tri- and tetra-functional (meth)acrylated polyester oligomers, Novolak polyester oligomers, di- and tri-functional aromatic urethane acrylate oligomers, hexafunctional aliphatic urethane acrylate oligomers, epoxy Novolak acrylates, and mixtures thereof.

One or more photoinitiators may be included in the preferred curable compositions to enhance the degree and rate of curing. Illustrative photoinitiators include 2-hydroxy-2-methyl-1-phenyl-propan-1-one, a 50:50 blend of 2-hydroxy-2-methyl-1-phenyl-propan-1-one and 2,4,6-trimethylbenzoyl diphenyl phosphine oxide, 1-hydroxycyclohexyl-phenylketone and 2-methyl- 1-[4-(methylthio)phenyl]-2-morpholino propan- 1-one. The photoinitiator may be present in amounts ranging from about 0.25 wt. % to about 20 wt. % of the compositions, and is preferably present in the range from about 2 wt. % to about 15 wt. % of the composition.

While the free-radical adhesives comprise reactive diluents, oligomers and other radiation-curable and non-curable components, these components are included in types and amounts which differentiate the adhesives from the lacquer compositions. More specifically, while both types of compositions include oligomers and reactive diluents, adhesive compositions include a far greater percentage of monofunctional components, with few or no components having at least three radiation-curable functional groups.

Preferably, such adhesives comprise from about 20 to about 60 wt. % monofunctional components, and from about 5 to about 50 wt. % difunctional components. In terms of oligomers and reactive diluents, the adhesives preferably comprise up to about 60 wt. %, and most preferably from about 15 to about 50 wt. %, oligomers, while the reactive diluents comprise up to about 90 wt. %, and most preferably from about 30 wt. % to about 75 wt. %, of the adhesives.

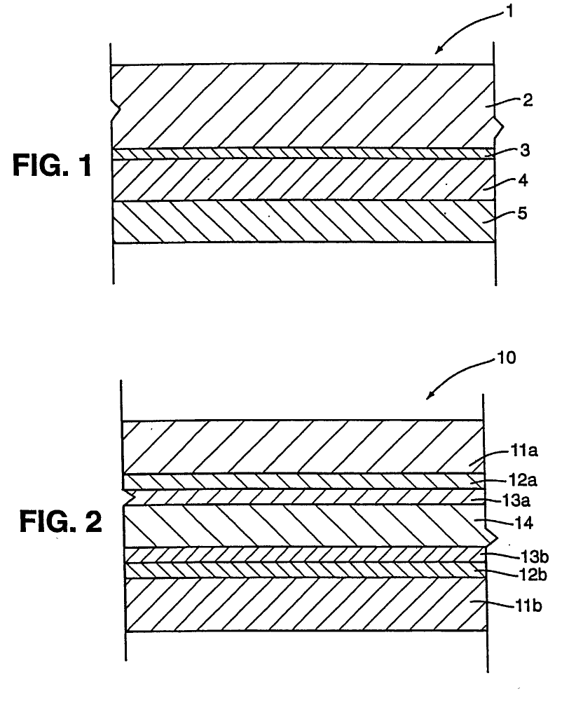

The inventive lacquer compositions may be used, alone or in combination, with the manufacture of a wide variety of optical media, including CD-DA, CD-ROM, CD-WORM, CD-R, and DVD, the latter including, but not limited to, DVD-R, DVD-RW, DVD-RAM, DVD-5, DVD-9 and DVD-18. By way of illustration of the lacquer composition, FIG. 1 illustrates in cross-section a portion of a CD-R 1 optical disc that uses an organic dye layer as the recording medium. Specifically, the CD-R 1 includes, in order, a polycarbonate substrate 2, an organic dye layer 3, a reflective layer 4. The radiation-curable lacquer of the present invention 5 is located on the outer surface of the disc.

As a means of illustrating the use of the inventive lacquer and adhesives in the preparation of a DVD, FIG. 2 is provided. This figure illustrates, in cross-section, a portion of a double-sided, single layer, DVD optical disc 10. The DVD includes, in order, a polycarbonate substrate 11a, a reflecting layer 12a, a layer of radiation-curable lacquer 13a, an adhesive layer 14, a second layer of radiation-curable lacquer 13b, a second reflecting layer 12a, and a second polycarbonate substrate 11b. The lacquer layers 13a and 13b are preferably included when the adhesive is cationic (or hybrid) in nature due to the tendency of this type of adhesive to corrode the reflecting layer, but may be omitted if heat-melt or free radical adhesives are used.

The adhesives and lacquers contemplated by the present invention may optionally contain other components without departing from the scope of the present invention. These components may or may not be radation-curable. For example, adhesion promoters, surfactants (e.g., LG-99, proprietary, Estron Chemical), stabilizers (e.g., hydroquinone monomethyl ether, BHT, Tetrakis[methylene-(3,5-di-tertbutyl-4-hydroxy-hydrocinnamate)]-methane), colorants (e.g., gold, yellow, blue, or the like) and antistatic agents may be included in the compositions.

It should be appreciated that the present invention also contemplates optical media, e.g., CD, DVD, that include one or more of the adhesives and lacquer compositions described herein, and which also possess the performance enhancements provided to the optical discs by the inventive compositions.

Conventional methods for preparing commercially acceptable optical media may be used in connection with the compositions of the present invention. As these methods are well known to those skilled in the art, a detailed description thereof is not provided herein.

The following examples are provided to further illustrate the various aspects of the present invention, and should not be construed as limiting their scope.

### EXAMPLE 1

This example illustrates the enhancement in cure provided by the inclusion of effective amounts of a thiol in accordance with an aspect of the present invention.

A radiation-curable free-radical composition was prepared using HDDA, Irgacure 184 (“Irg 184”), and MBO in the amounts set forth in the Table.

| Composition | HDDA (wt. %) | Irg 184 (wt. %) | MBO (wt. %) |
|---|---|---|---|
| 1 | 99 | 1 | 0 |
| 2 | 97 | 3 | 0 |
| 3 | 98.9 | 1 | 0.1 |

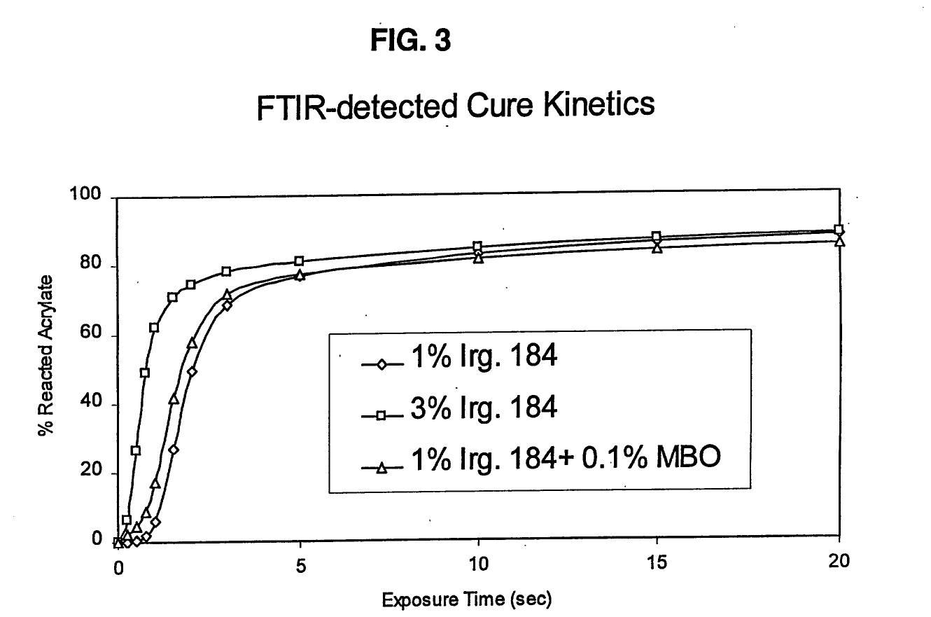

A Fourier Transform IR (“FTIR”) curve for each of the foregoing compositions was generated using the procedure as set forth at page 915 of Decker, Kinetic Study of Light-Induced Polymerization by Real-Time UV and IR Spectroscopy, 30 J. Polymer Sci., 913-928, (1992). Each curve plots the degree of cure per unit of time, as measured by the percent reacted acrylate unsaturation (% RAU) for the composition undergoing testing. The curves are set forth in FIG. 3.

An analysis of the curves demonstrates that the composition containing 0.1 wt. % NIBO demonstrated an enhanced cure rate (up to about 5 seconds).

### EXAMPLE 2

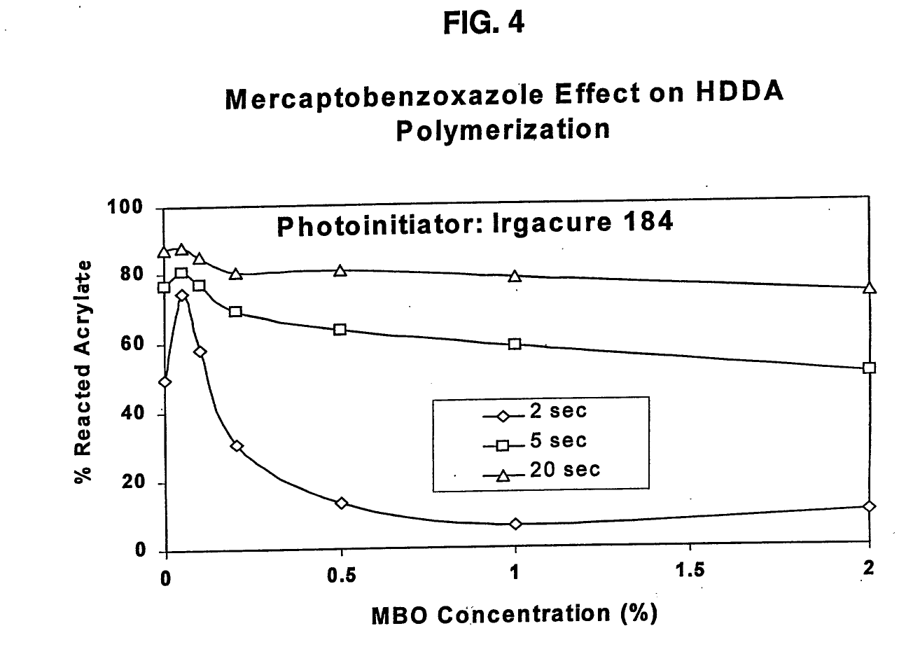

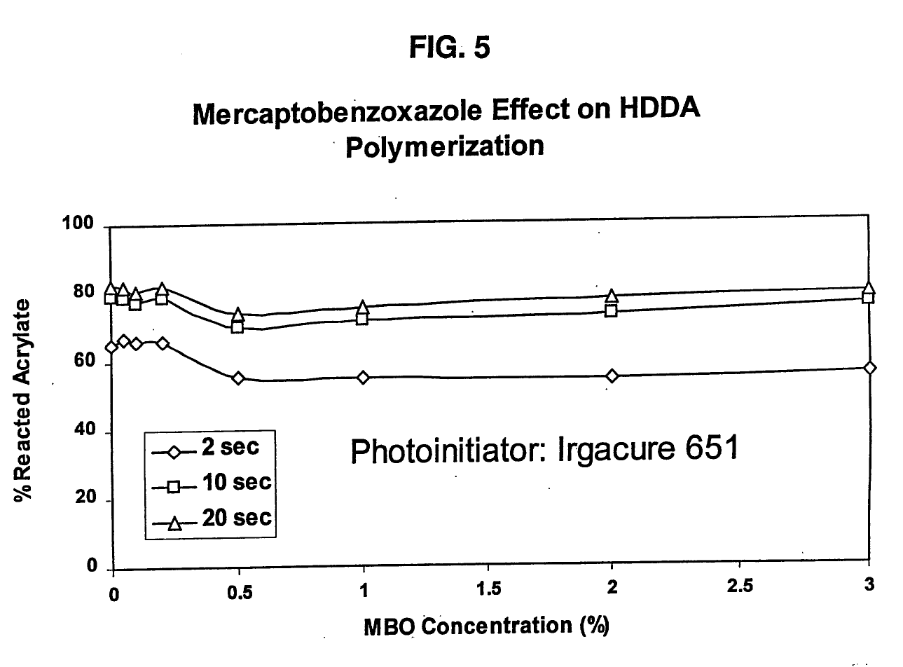

A further series of radiation-curable compositions were prepared using HDDA and 1 wt. % Irgacure 184 or Irgacure 651, with the amount of MBT being varied from 0 wt. % to 2 wt. % of the composition. The % RAU of each composition after curing was determined, and is set forth in FIGS. 4 and 5

An analysis of these curves indicates that the % RAU is maximized at about 0.1 wt. % in the Irgacure 184-containing composition, and at about 0.25 wt. % in the Irgacure 651-containing composition.

### EXAMPLE 3

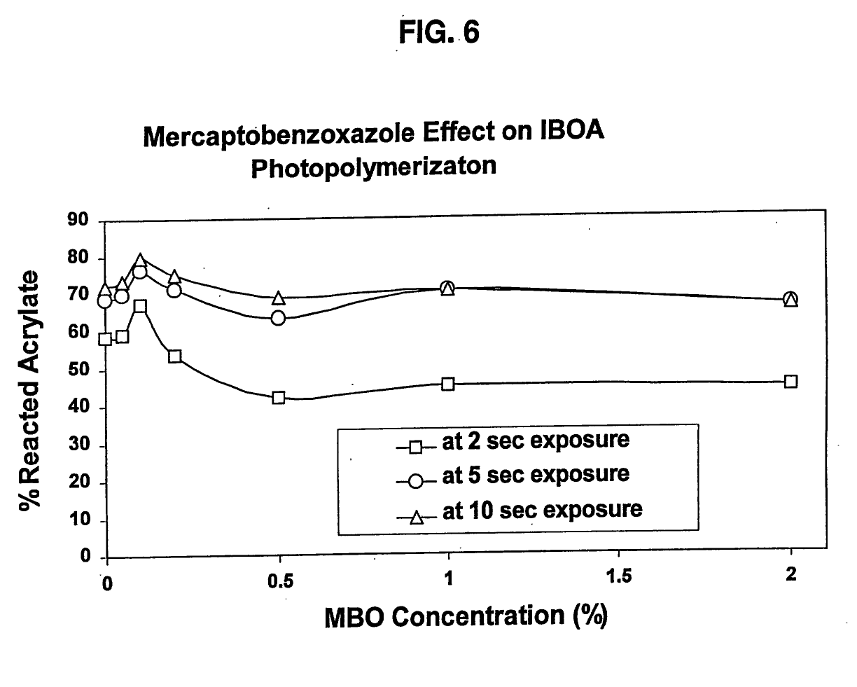

A radiation-curable composition was prepared using IBOA and 1 wt. % Irgacure 184, with the amount of MBO being varied from 0 wt. % to 2 wt. % of the composition. The % RAU of this composition after curing is set forth in FIG. 6.

An analysis of this curve indicates that the % RAU is maximized at about 0.1 wt. %.

### EXAMPLE 4

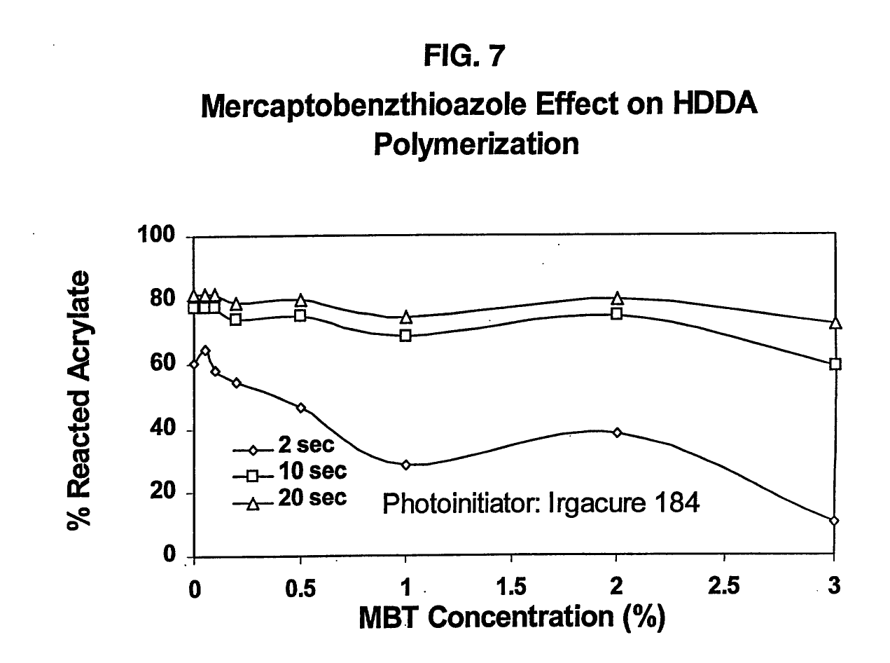

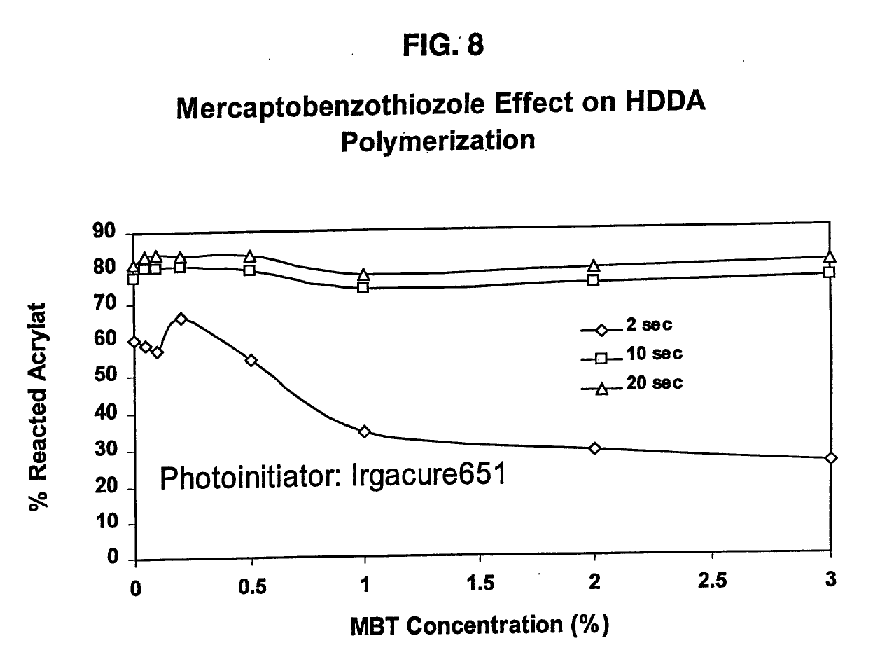

Two radiation-curable compositions were prepared using HDDA and 1 wt. % Irgacure 184 or Irgacure 651. Varying amounts of MBT (from 0 wt. % to 2 wt. %) were added to each composition, with the %RAU of each such composition being obtained and plotted in FIGS. 7 and 8.

An analysis of these curves indicates that the %RAU is maximized at about 0.1 wt. % in the Irgacure 184-containing composition, and at about 0.25 wt. % in the Irgacure 651 -containing composition.

### EXAMPLE 5

A radiation-curable free-radical composition was prepared using HDDA, Irgacure 184 (“Irg 184”), and MBO in the amounts set forth in the Table.

| Composition | HDDA (wt. %) | Irg 184 (wt. %) | MBO (wt. %) |
|---|---|---|---|
| 1 | 99 | 1 | 0 |
| 2 | 99.95 | 1 | 0.05 |
| 3 | 98.9 | 1 | 0.1 |

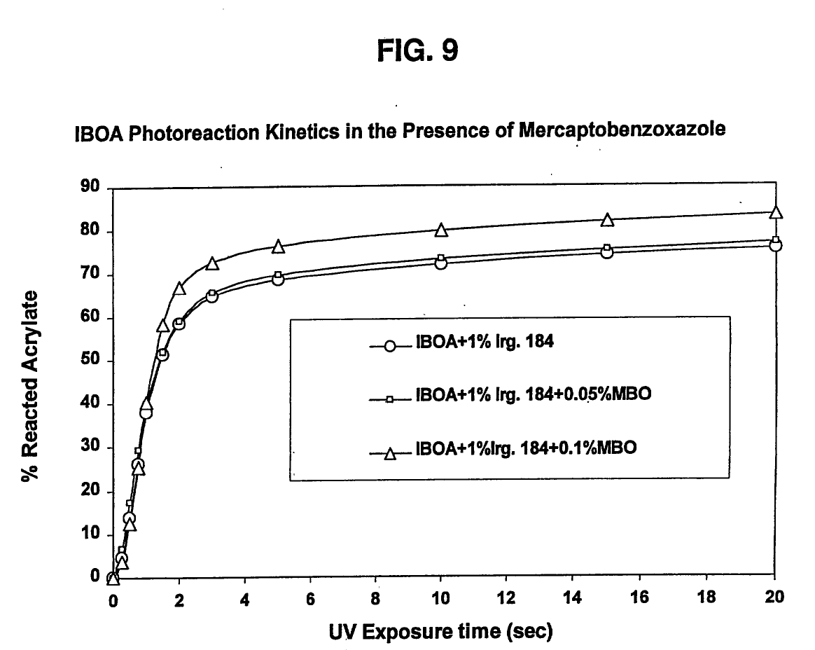

FTIR curves are set forth in FIG. 9. An analysis of the curves demonstrates that the compositions containing 0.05 wt. % and 0.1 wt. % MBO demonstrate an enhanced cure rate, with the 0.1 wt. % MBO composition being preferred.

### EXAMPLE 6

The following is illustrative of the radiation-curable lacquers contemplated by the present invention.

| Component | Weight Percent |
|---|---|
| Propoxylated glycerol triacrylate | 21 |
| Tripropylene glycol | 30.5 |
| Ethoxylated₄ Bisphenol A diacrylate | 15.5 |
| Tetrahydrofurfuryl acrylate | 8.45 |
| Acrylic acid | 0.5 |
| Epoxy Novolac acrylate (60%): | |
| Trimethylol propane triacrylate (40%) | 10 |
| 2-benzyl-2-dimethylamino-1- | 6 |
| (4-morpholinophenyl)-butanone-1 | |
| Bis(2,6-dimethoxybenzoyl)-2,4,4-trimethyl | 6 |
| pentyl phosphine oxide (25%): | |
| 2-hydroxy-2-methyl-1-phenyl- | |
| propan-1-one (75%) | |
| 1-hydroxy-cyclohexyl-phenyl-ketone | 1 |
| LG-99 (proprietary) | 0.5 |
| HQMME | 0.05 |
| Total | 100 |

Four portions of the foregoing lacquer were drawn. 0.5 wt. % MBO was added to the first portion, 1 wt. % MBO was added to the second portion, 0.5 wt. % 1-phenyl-1H-tetrazole-5-thiol was added to the third portion, and 1 wt. % 1-phenyl-1H-tetrazole-5-thiol was added to the fourth portion. Each portion was applied onto a CD-R, cured, and subsequently subjected to an 85° C./85% relative humidity environment for 96 hours.

None of the CD-R reflective layers exhibited any visually-observable corrosion. Further, the first and second portions exhibited 0% delamination, while the third and fourth portions exhibited 10% and 15% delamination, respectively.

### EXAMPLE 7

A CD lacquer composition marketed by DSM Desotech, Elgin, Ill. (650-020) was divided into three portions. 0.5 wt. % MBO was added to the first portion, 0.5 wt. % 1-phenyl-1H-tetrazole-5-thiol was added to the second portion, with the third portion functioning as a control. Each resulting lacquer was applied onto a CD-R, cured, and subsequently subjected to an 85° C./85% relative humidity environment for 96 hours.

No delamination was observed relative to any of the three lacquers, while some corrosion was noted on the third (control) CD-R reflective layer (1 on a scale of 0 to 5, with 0 representing no corrosion and 5 representing substantially complete corrosion of the reflective layer) upon visual inspection under 25× magnification. A corrosion level of 0 was observed on the CD-Rs bearing the first and second lacquers.

### EXAMPLE 8

This example provides a comparison of the cure properties of the optical disc lacquer composition set forth in Example 6 with and without the thiol component.

Two lacquer compositions were prepared. Composition 8A consisted of the lacquer set forth in Example 6. Composition 8B consisted of the lacquer set forth in Example 6, with the exception that the tripropylene glycol component was reduced to 30.0 wt. %, and MBO was included at 0.5 wt. %.

Both compositions were subjected to curing under identical conditions, and FTIR data was collected in accordance with the procedure identified in Example 1. The cure (% RAU) data is provided below:

| Time (sec) | 8A (% RAU) | 8B (% RAU) |
|---|---|---|
| 0.000 | 0.00 | 0.00 |
| 0.050 | 32.76 | 41.70 |
| 0.075 | 52.08 | 58.46 |
| 0.100 | 63.96 | 66.44 |
| 0.150 | 71.01 | 72.23 |
| 0.200 | 74.6 | 77.03 |
| 0.350 | 78.23 | 80.85 |
| 0.500 | 80.64 | 82.73 |
| 1.000 | 83.41 | 86.40 |
| 2.000 | 85.62 | 88.58 |
| 5.000 | 88.8 | 93.71 |
| 10.000 | 91.03 | 95.15 |

The data demonstrates that, at even relatively low levels, the addition of a thiol to an optical disc lacquer composition can provide a beneficial increase in cure rate, and degree of cure at a given time.

This example further suggests that photoinitiator levels in lacquer compositions may be decreased in preference to thiol addition, with the relative photoinitiator/thiol proportion being balanced to obtain the desired lacquer cure performance.

### EXAMPLE 9

The following is illustrative of a cationic adhesive contemplated by the present invention.

| Base Adhesive | Weight Percent |
|---|---|
| Diglycidyl ether of Bisphenol F | 49.53 |
| Novolac epoxy resin | 43.85 |
| Ethylene glycol | 3.10 |
| Surfactant | 0.52 |
| Arylsulphonium hexafluoroantimony salt | 3.00 |
| Total | 100.00 |

Two portions of the Base Adhesive were drawn. 1 wt. % of MBO was added to the first portion, with 1 wt. % 1-phenyl-1H-tetrazole-5-thiol added to the second portion. Each portion was screen printed onto a lacquered aluminum surface to a 1 mm thickness, cured by exposure to UV (0.25 J under an H lamp). Each adhesive cured very slowly, and did not exhibit complete cure through.

The cure speed of DVD adhesives is desirably slower than lacquers because two discs must be adhered together (typically within about 3-5 seconds after UV-exposure). If an adhesive cures too quickly, however, the adhesive on each disc, upon contact with one another, will not provide a strong bond therebetween. Complete cure through of the adhesive is also important. The absence of complete cure through will also result in inadequate adhesion.

The cure speed and cure through for cationic epoxy-based adhesives can be quantitatively determined in a manner analogous to the %RAU method discussed herein, except that the percent reacted oxirane (“% RO”), determined at 910 cm⁻¹ (as opposed to 810 cm⁻¹ for % RAU), is used to measure the degree of adhesive curing. Generally, the % RO should range between about 10-25 at 10 seconds, and increase to at least about 30 % RO, and desirably to at least about 40 % RO, at 20 seconds. Generally, an adhesive on the first disc that exceeds a % RO of about 40 will not bond well to adhesive on the second disc.

Four addition portions of the Base Adhesive were drawn. 0.5 wt. % MBO was added to the first portion, 0.5 wt. % 1-phenyl-1H-tetrazole-5-thiol was added to the second portion, 0.1 wt. % MBO was added to the third portion, and 0.1 wt. % 1-phenyl-1H-tetrazole-5-thiol was added to the fourth portion. Each portion was again screen printed onto a lacquered aluminum surface to a 1 mm thickness, and cured by exposure to UV radiation (0.25 J under an H lamp).

The first and second portions did not cure. The third portion cured relatively slowly, and did not exhibit complete cure through. The fourth portion cured, and exhibited no corrosion of the aluminum surface under visual inspection after exposure to a 85° C./85% relative humidity environment for 96 hours. Corrosion was determined on a scale of 0 to 5, with 0 constituting no observable corrosion (when held up to a light source), and 5 constituting severe corrosion (the disc was almost transparent when held up to a light source).

The degree of cure can also be determined by touch. For example, an adhesive that remains tacky to the touch 24 hours after exposure to curing radiation is unacceptable. In the present case, the adhesives with MBO added did not exhibit adequate levels of cure (i.e., down to 0.1 wt. % MBO).

### EXAMPLE 10

Glutathione and 2-MBO were introduced into the CD-R lacquer compositions set forth in Example 6, at varying weight percents, with the compositions then being applied and cured on a series of CD-Rs. The resulting CD-Rs were immersed in a 5 wt. % NaCl aqueous solution for 48 hours. After drying, each disc was examined and assigned a corrosion rating. The results are set forth in the following table.

| | | Amount | | |
|---|---|---|---|---|
| Sample | Corrosion inhibitor | (%) | Delamination | Corrosion* |
| A | 2-MBO | 0.25 | none | Slight |
| B | 2-MBO | 0.50 | none | Slight |
| C | 2-MBO | 0.75 | none | Slight |
| D | 2-MBO | 1.00 | none | Slight |
| E | Glutathione | 0.25 | none | Slight |
| F | Glutathione | 0.50 | none | Slight |
| G | Glutathione | 0.75 | none | Slight |
| H | Glutathione | 1.00 | none | Slight |

*denotes the degree of corrosion as observed using a microscope with a 25× magnification.

The results demonstrate that both glutathione and 2-MBO provided good corrosion resistance, even when used at relatively low levels.

### EXAMPLE 11

This example demonstrates the effect of thiol addition in a free-radical adhesive compositions.

The adhesive compositions described in the following Table were prepared, applied onto an optical disc, and exposed to UV radiation until solidified.

Thereafter, each disc was placed in an 85° C./85% relative humidity environment for 20 hours. The discs were then removed from the environment, and the degree of corrosion ascertained by visual observation. The results are provided in the Table.

TABLE

| | Adhesive A | | | Adhesive B | | Adhesive C | | | Adhesive D | | | |
|---|---|---|---|---|---|---|---|---|---|---|---|---|
| | (wt. %) | | | (wt. %) | | (wt. %) | | | (wt. %) | | | |
| Component | A1 | A2 | A3 | B1 | B2 | C1 | C2 | C3 | D1 | D2 | D3 | D4 |
| Oligomer A | 35 | 35 | 35 | 35.9 | 35.9 | 35 | 35 | 35 | | | | |
| Oligomer B (80% aliphatic | | | | | | | | | 55 | 55 | 70 | 70 |
| acrylate/20% hexanediol | | | | | | | | | | | | |
| diacrylate) | | | | | | | | | | | | |
| Dimethylacrylamide | 5 | 5 | 5. | 7 | 7 | 5 | 5 | 5 | 5 | 5 | 5 | 5 |
| 4-HBA | 13.9 | 13.8 | 13.8 | 32 | 32 | 13.9 | 13.8 | 12.8 | 13.9 | 13.8 | 12.9 | 12.8 |
| HDDA | 5 | 5 | 5 | | | 5 | 5 | 5 | 5 | 5 | 5 | 5 |
| Reactive Diluent A | 35 | 35 | 35 | | | 5 | 5 | 5 | | | | |
| Photointiators A | 6.1 | 6.1 | 6.1 | | | 6.1 | 6.1 | 6.1 | 6.1 | 6.1 | 6.1 | 6.1 |
| Reactive Diluent B | | | | 18 | 18 | | | | | | | |
| Adhesion Promoter | | | | 1 | 1 | | 1 | 1 | | | | |
| Photoinitiators B | | | | 6.1 | 6.1 | | | | | | | |
| TPGDA | | | | | | | | | 15 | 15 | 0 | 0 |
| THIECTA | | | | | | 30 | 39 | 39 | | | | |
| MBO | | 0.1 | 0.5 | | 0.1 | | 0.1 | 0.1 | | 0.1 | 0 | 0.1 |
| Viscosity | 460 | 460 | 465 | 380 | 380 | 1080 | 1080 | 1080 | 245 | 240 | 706 | 700 |
| Corrosion | Corr. | Good | Good | Good | Better | Corr. | Good | Good | Corr. | Good | | |
| | present | | | | than B1 | present | | | present | After 3 | present | After3 |
| | | | | | | | | | | Days | | Days |

The data indicates that the addition of a thiol component, e.g., MBO, provides enhanced corrosion resistance to the free-radical adhesives relative to a reflective metallic surface (silver and alloys thereof) of an optical disc, even after exposure to a relatively harsh environment.

References herein to a component that is radiation-curable includes, but is not limited to, components that can be directly cured with radiation, e.g., electron-beam radiation, and components that can be cured by radiation with the aid of a suitable photoinitiator.

Any references cited herein, including patents, patent applications, and publications, are hereby incorporated in their entireties by reference. Further, any reference herein to a component in the singular is intended to indicate and include at least one of that particular component, i.e., one or more.

While this invention has been described with an emphasis upon preferred embodiments, it will be obvious to those of ordinary skill in the art that variations of the preferred embodiments may be used and that it is intended that the invention may be practiced otherwise than as specifically described herein. Accordingly, this invention includes all modifications encompassed within the spirit and scope of the invention as defined by the following claims. Moreover, the present invention provides a number of improved properties in uncured and cured optical media lacquer and adhesive compositions, products that include these compositions. The present invention should be interpreted as including any and all combinations of the foregoing, regardless of whether a specific combination is explicitly set forth herein.

What is claimed is:

1. A radiation-curable adhesive composition for a digital versatile disc (DVD) that includes a reflective or semi-reflective layer, the adhesive composition comprising components that undergo polymerization when exposed to radiation and a component selected from the group consisting of acyclic thiols, heterocyclic compounds of the formula R-SH or R¹-R², and mixtures thereof in an amount sufficient to inhibit corrosion of the reflective or semi-reflective layer,
wherein R is a heterocycle, R¹ is a substituted or unsubstituted phenyl as a substituent of R² or forming with R² a bicyclic structure, and R² is a heterocycle comprising at least one double bond and at least two N atoms.

2. The radiation-curable composition according to claim 1, wherein the corrosion inhibiting component is a heterocyclic compound of the formula R-SH or R¹-R², and R is selected from the group consisting of:
(a) a bicyclic compound comprising a heterocycle and a substituted or unsubstituted phenyl,
(b) a single-ring heterocycle comprising a substituted or unsubstituted phenyl component as a substituent thereof, and
(c) a heterocycle comprising N, S or O in its ring structure, and wherein R¹-R2 is selected from the group consisting of:
(a) a bicyclic compound comprising a heterocycle and a substituted or unsubstituted phenyl, and
(b) a single-ring heterocycle comprising a substituted or unsubstituted phenyl component as a substituent thereof.

3. The radiation-curable adhesive composition according to claim 2, wherein N and N, S or O are in the heterocycle ring.

4. The radiation-curable adhesive according to claim 3, wherein the amount of R-SH, R¹-R2 or mixtures thereof ranges up to about 0.5 wt. %, based on the total weight of the radiation-curable composition.

5. The radiation-curable composition according to claim 3, wherein the corrosion-inhibiting component is a heterocyclic compound of the formula R-SH, and R is a bicyclic compound comprising a heterocycle and a substituted or unsubstituted phenyl.

6. The radiation-curable composition according to claim 5, wherein the corrosion-inhibiting component is 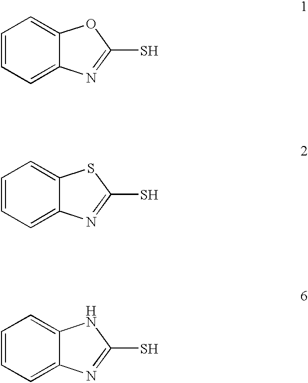
or mixtures thereof.

7. The radiation-curable composition according to claim 6, wherein the corrosion-inhibiting component is

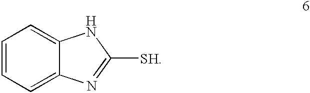

8. The radiation-curable composition according to claim 3, wherein the corrosion-inhibiting component is a heterocyclic compound of the formula R-SH, and R is a single-ring heterocycle.

9. The radiation-curable composition according to claim 3, wherein the corrosion-inhibiting component is 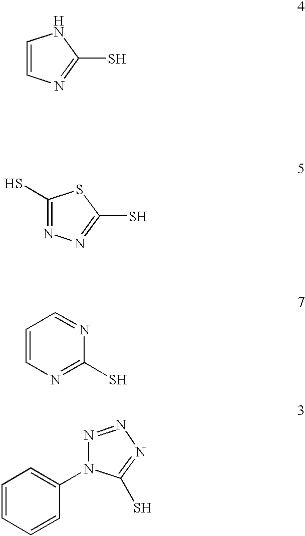
or mixtures thereof.

10. The radiation-curable composition according to claim 9, wherein the corrosion-inhibiting-component is

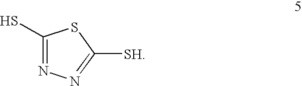

11. The radiation-curable composition according to claim 3, wherein the corrosion-inhibiting component is a heterocyclic compound of the formula R¹-R2, and wherein R¹-R2 is a bicyclic compound comprising a heterocycle and a substituted or unsubstituted phenyl.

12. The radiation-curable composition according to claim 11, wherein the corrosion-inhibiting component is 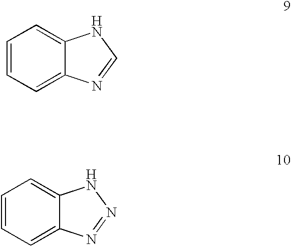
or mixtures thereof.

13. The radiation-curable composition according to claim 3, wherein the corrosion-inhibiting component is a heterocyclic compound of the formula R¹-R², and wherein R¹-R² is a single-ring heterocycle comprising a substituted or unsubstituted phenyl component as a substituent thereof.

14. The radiation-curable composition according to claim 13, wherein the corrosion-inhibiting component is

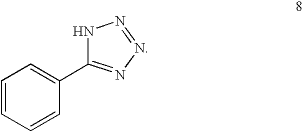

15. The radiation-curable adhesive composition according to claim 1, wherein the composition cures via cationic polymerization.

16. The radiation-curable adhesive according to claim 1, wherein the adhesive is a hybrid adhesive, the hybrid adhesive further comprising a radiation-curable component that cures via free-radical polymerization.

17. The radiation-curable composition according to claim 1, wherein the corrosion-inhibiting component is an acyclic thiol.

18. The radiation-curable composition according to claim 17, wherein the acyclic thiol comprises a chain which includes a heteroatom.

19. The radiation-curable composition according to claim 18, wherein the acyclic thiol comprises a chain of up to 16 atoms, a plurality of heteroatoms at least two of which are N atoms, and a plurality of polar functional groups.

20. Optical media comprising a reflective or semi-reflective layer and a cured radiation-curable adhesive composition, the radiation-curable composition comprising components that undergo polymerization when exposed to radiation and a component selected from the group consisting of acyclic thiols, heterocyclic compounds of the formula R-SH and R¹-R², and mixtures thereof in an amount sufficient to inhibit corrosion of the reflective or semi-reflective layer, wherein R is a heterocycle, R¹ is a substituted or unsubstituted phenyl as a substituent of R² or forming with R² a bicyclic structure, and R² is a heterocycle comprising at least one double bond and at least two N atoms.

21. The optical media according to claim 20, further comprising at least two substrates, wherein the reflective or semi-reflective layer comprising silver, gold, silicon, copper, aluminum or alloys thereof, and wherein the cured adhesive bonds at least two of the substrates to one another.

22. The optical media according to claim 20, wherein the optical media is a DVD comprising at least two substrates and meets at least one of the following criteria:
(a) the substrates remain adhered to one another after the DVD is dropped on its edge onto a concrete floor from a height of 75 cm;
(b) the substrates do not delaminate after exposure to an environment consisting of 80° C./85% relative humidity for at least 1000 hours;
(c) the cured adhesive exhibits a cured film elongation at break of at least 20%;
(d) the cured adhesive exhibits shrinkage upon cure of no greater than about 10%; or
(e) the cured adhesive exhibits a shear strength of about 10 lbs to about 100 lbs.

23. The optical media according to claim 22, wherein the optical media meets at least two of the criteria (a)-(e).

24. The optical media according to claim 23, wherein the optical media meets at least three of the criteria (a)-(e).

25. The optical media according to claim 20, wherein the radiation-curable composition comprises up to about 0.3 wt. % of the corrosion-inhibiting component.

26. The optical media according to claim 21, wherein corrosion is limited to no more than about 15% of the total reflective and semi-reflective layer after the optical media is exposed to an environment of 80° C./85% relative humidity environment for 48 hours.

27. The optical media according to claim 26, wherein the media exhbiits no more than slight corrosion after the optical media is exposed to an environment of 80° C./85% relative humidity environment for 48 hours.

28. The optical media according to claim 27, wherein the media exhibits no more than slight corrosion after exposure to an aqueous 5 wt. % NaCl solution for 48 hours.

29. The optical media according to claim 21, wherein the corrosion-inhibiting component is an acyclic thiol.

30. The optical media according to claim 21, wherein the corrosion inhibiting component is a heterocyclic compound of the formula R-SH or R¹-R², and R is selected from the group consisting of:
(a) a bicyclic compound comprising a heterocycle and a substituted or unsubstituted phenyl,
(b) a single-ring heterocycle comprising a substituted or unsubstituted phenyl component as a substituent thereof, and
(c) a heterocycle comprising N, S or O in its ring structure, and wherein R¹-R² is selected from the group consisting of:
(a) a bicyclic compound comprising a heterocycle and a substituted or unsubstituted phenyl, and
(b) a single-ring heterocycle comprising a substituted or unsubstituted phenyl component as a substituent thereof.

31. The optical media according to claim 21, wherein the optical media is a DVD and the radiation-curable composition cures by cationic polymerization.

32. A radiation-curable optical disc adhesive or lacquer composition comprising components that undergo free-radical polymerization when exposed to radiation and a cure-enhancing amount of a heterocyclic compound comprising a N atom and a double bond.

33. The radiation-curable optical disc composition according to claim 32, wherein the amount of the heterocyclic compound does not exceed about 5 wt. % of the composition.

34. The radiation-curable optical disc composition according to claim 33, wherein the composition is an optical disc lacquer.

35. The radiation-curable optical disc composition according to claim 34, wherein the heterocyclic compound further includes at least two N atoms and at least one double bond.

36. The radiation-curable optical disc composition according to claim 35, wherein the amount of the heterocyclic compound does not exceed about 1 wt. % of the composition.

37. The radiation-curable optical disc composition according to claim 34, wherein the heterocyclic compound is selected from the group consisting of Compounds 1-12 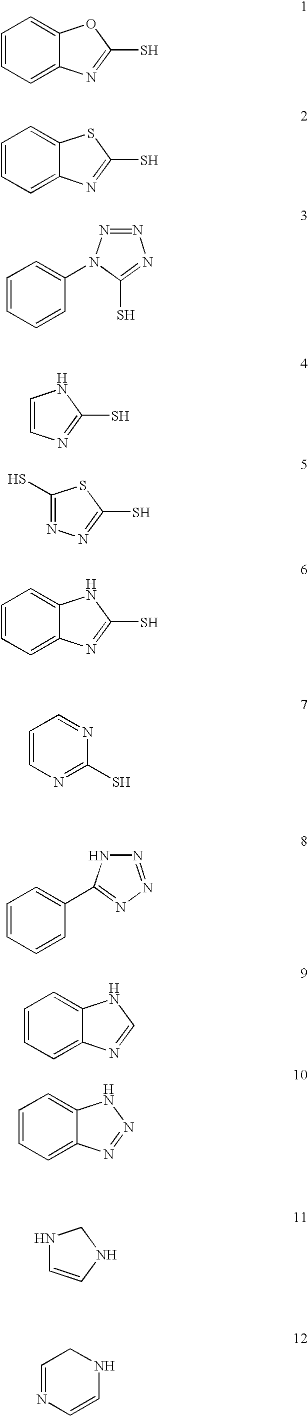
and mixtures thereof.

38. Optical media comprising the cured radiation-curable composition set forth in claim 32.

39. Optical media according to claim 38, wherein the amount of the heterocyclic compound does not exceed about 5 wt. % of the uncured composition.

40. Optical media according to claim 39, wherein the cured composition is an optical disc lacquer.

41. Optical media according to claim 40, wherein the heterocyclic compound further includes at least two N atoms and at least one double bond.

42. Optical media according to claim 41, wherein the amount of the heterocyclic compound does not exceed about 1 wt. % of the uncured composition.

43. Optical media according to claim 38, wherein the heterocyclic compound is selected from the group consisting of Compounds 1- 12 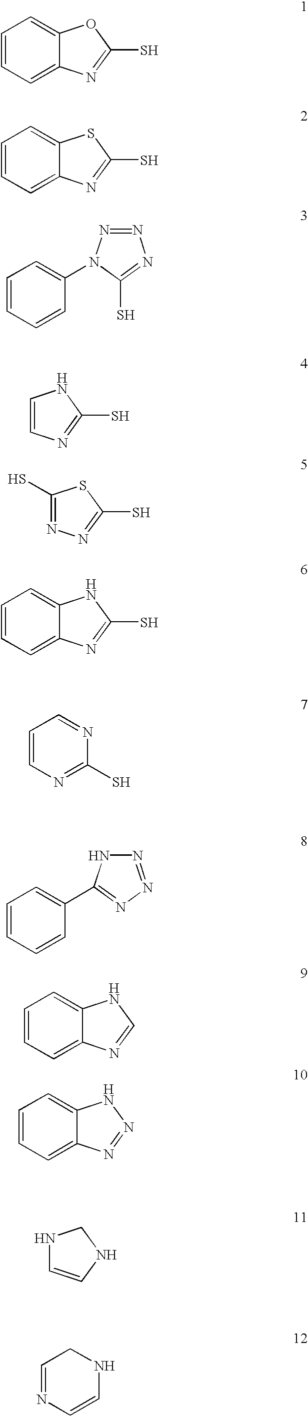
and mixtures thereof.

44. Optical media comprising the cured radiation-curable composition set forth in claim 29.
